(19) United States
(12) Patent Application Publication
(10) Pub. No.: US 2014/0218498 A1
(43) Pub. Date: Aug. 7, 2014

(54) BLINK MEASUREMENT DEVICE, METHOD THEREFOR AND PROGRAM

(71) Applicant: Makoto Sato, Tokyo (JP)

(72) Inventor: Makoto Sato, Tokyo (JP)

(73) Assignee: CANON KABUSHIKI KAISHA, Tokyo (JP)

(21) Appl. No.: 14/241,020

(22) PCT Filed: Aug. 22, 2012
(86) PCT No.: PCT/JP2012/005247

§ 371 Date: Feb. 25, 2014

(30) Foreign Application Priority Data
Aug. 26, 2011 (JP) 2011-184618

(51) Int. Cl. G06K 9/00

(52) U.S. Cl. CPC G06K 9/00604
USPC 348/78

(57) ABSTRACT

A blink measurement device includes an acquisition unit configured to acquire motion information of a subject's eye, and an analysis unit configured to obtain start information about a blink of the subject's eye based on the motion information.

### TECHNICAL FIELD

The present invention relates to a device for measuring a blink, and more particularly, to a device for obtaining blink information from a motion of an eye.

### BACKGROUND ART

A blink (blinking) refers to opening and closing of eyelids in an animal to wet a surface of the cornea and conjunctiva and circulate tear fluid. A blink is a physiological phenomenon, but can be applied to active use, for example, to determine whether a driver is dozing as proposed in Japanese Patent Application Laid-Open No. 9-39603.

Further, eyes are photographed by a photographing device for an ophthalmological clinic. However, if a blink occurs during the photography, an image acquired at that time is not useful. Accordingly, a process for detecting the blink and removing image information obtained during the blink is performed. For such blink detection, a blink detection method using a wavelet transform is discussed in Japanese Patent Application Laid-Open No. 10-52403.

Meanwhile, a human eyeball constantly performs a small movement known as an involuntary eye movement during fixation. An optical system for detecting a position of the eyeball is separately provided in the photographing device for an ophthalmological clinic, and a laser light for measurement follows a position of the eyeball. However, since detection of the eyeball position may be impossible at the time of blinking, tracking of the eyeball needs to restart after the blink. In this case, delay occurs. Further, the position of the eyeball is often changed before and after the blink, and eyeball position information before the blink occurrence may be unusable. In this case, if the occurrence of the blink can be predicted, a rapid response is possible. However, with a blink detection method of the related art, it is difficult to predict the occurrence of the blink in advance.

### CITATION LIST

### Patent Literature

### [PTL 1]

### Japanese Patent Application Laid-Open No. 9-39603

### [PTL 2]

### Japanese Patent Application Laid-Open No. 10-52403

### SUMMARY OF INVENTION

The present invention is directed to a mechanism for obtaining blink start information.

The blink measurement device according to the present invention includes an acquisition unit configured to acquire motion information of a subject's eye, and an analysis unit configured to obtain start information about a blink of the subject's eye based on the motion information.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating a configuration of a blink measurement device according to the present invention.

FIG. 2 is a diagram illustrating a basic configuration of a computer that realizes each unit of a blink measurement device according to a first exemplary embodiment using software.

FIG. 3 illustrates a flowchart of a blink prediction method according to the present invention.

FIG. 4 is a diagram illustrating a configuration of an SLO.

FIG. 5 is a diagram illustrating a scanning laser ophthalmoscope (SLO) image.

FIG. 6 is a diagram illustrating an example of a temporal change of an eyeball position.

FIG. 7 is a diagram illustrating an example of a temporal change of an eyeball position.

FIG. 8 is a diagram illustrating an example of a temporal change of an eyeball position.

FIG. 9 is a diagram illustrating a configuration of a blink measurement device according to a second exemplary embodiment of the present invention.

FIG. 10 is a diagram illustrating eyeball position prediction after a blink.

FIG. 11 is a diagram illustrating template matching in the second exemplary embodiment.

FIG. 12 is a diagram illustrating a configuration of a blink measurement device according to another exemplary embodiment.

### DESCRIPTION OF EMBODIMENTS

Various exemplary embodiments, features, and aspects of the invention will be described in detail below with reference to the drawings.

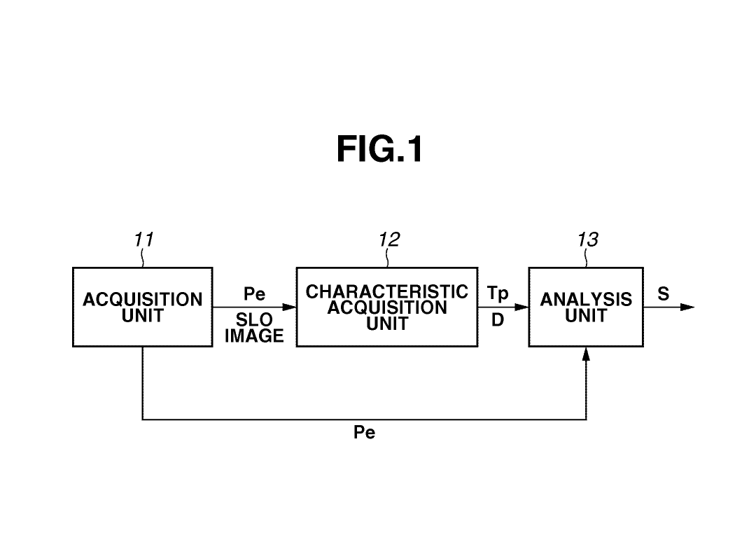

FIG. 1 illustrates a basic configuration of a blink measurement device 1 according to the present invention. In FIG. 1, an acquisition unit 11 continuously detects a motion of an eyeball of a subject's eye and outputs position information. A characteristic acquisition unit 12 analyzes the position information input from the acquisition unit 11 and acquires a characteristic of the subject's eye. An analysis unit 13 acquires blink start information from the characteristic acquired by the characteristic acquisition unit 12. Further, the occurrence of the blink can be predicted in advance and its result can be output.

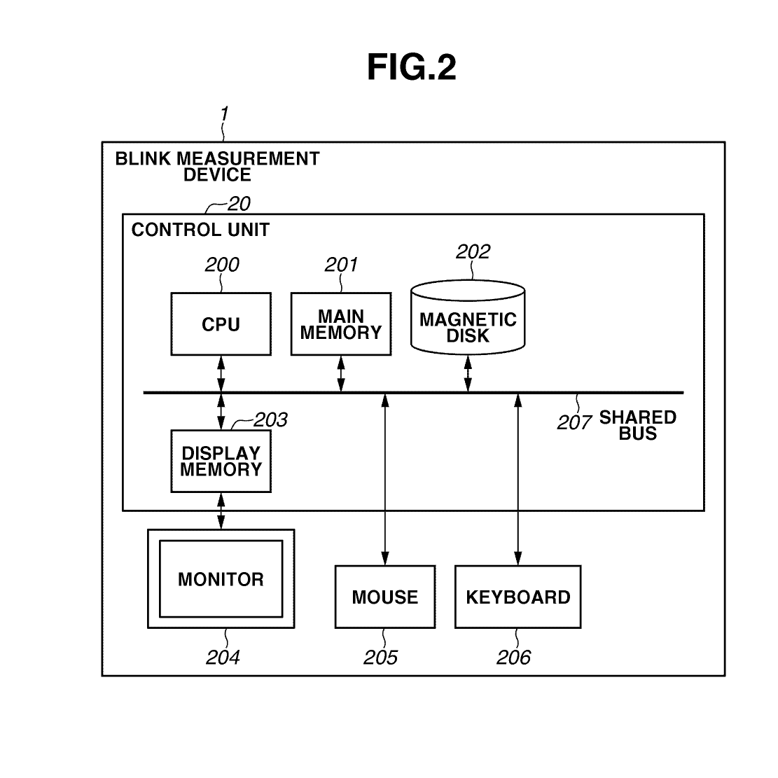

FIG. 2 is a diagram illustrating a basic configuration of a computer for realizing a function of each unit of the blink measurement device 1 illustrated in FIG. 1 by executing software.

The blink measurement device 1 includes a control unit 20, a monitor 204, a mouse 205, and a keyboard 206. Further, the control unit 20 includes a central processing unit (CPU) 200, a main memory 201, a magnetic disk 202, a display memory 203, and a shared bus 207.

The CPU 200 executes various controls such as communication with a database 2 and entire control of the blink measurement device 1 by executing a program stored in the main memory 201. The CPU 200 mainly controls an operation of each element of the blink measurement device 1.

The main memory 201 stores a control program executed by the CPU 200, and provides a work area when the program is executed by the CPU 200.

The magnetic disk 202 stores various application software, such as an operating system (OS), device drivers for peripheral devices, and a program for a blink prediction process, which will be described below.

The display memory 203 temporarily stores display data for the monitor 204.

The monitor 204 performs display of the display data stored in the display memory 203 under control of the CPU 200.

The mouse 205 and the keyboard 206 are used by a user (a doctor) to perform pointing input and perform character input etc.

The respective components are connected via the common bus 207 so that the components can communicate with each other.

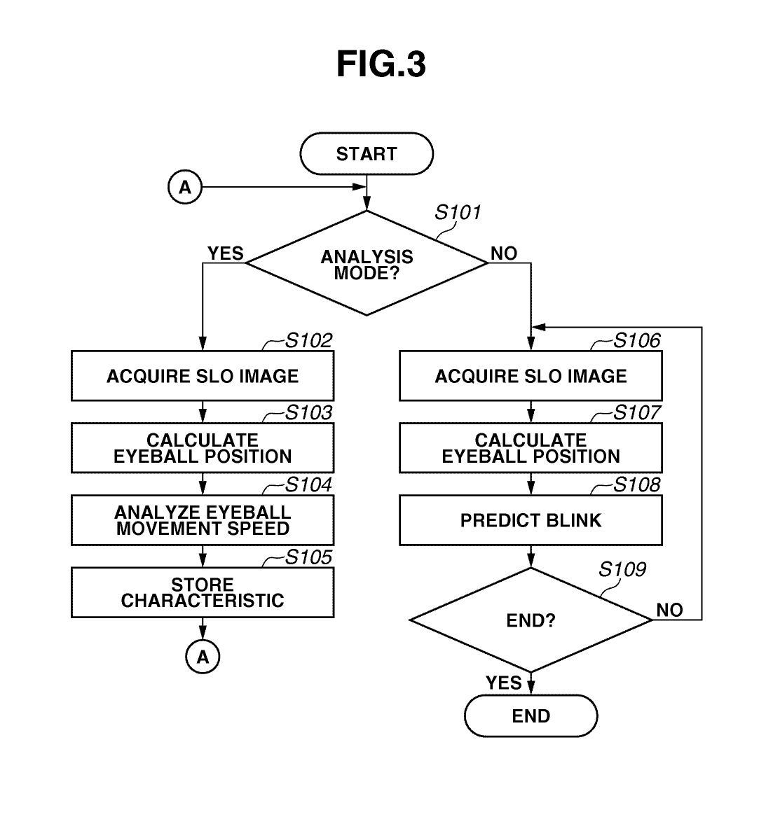

The above-described device may include a general computer and a peripheral device. Further, a control procedure of the blink measurement device according to the present invention, which will be described below with reference to FIG. 3, may be realized as a program to be executed by a computer.

Hereinafter, details of each unit and a flow of the process will be described according to a flowchart illustrated in FIG. 3.

### <Step S101>

A PC switches a subsequent process to either an analysis mode or a prediction mode based on whether analysis of blink for a subject's eye has already been performed. This is because the blink measurement device according to the present invention has a process for analyzing a characteristic at the time of the blinking of the subject's eye in advance. The process proceeds to step S102 in the case of the analysis mode (Yes) and to step S106 in the case of the prediction mode (No).

The characteristic acquisition unit 12 and the analysis unit 13 perform the similar processes to obtain information about blinking start of the subject's eye. However, in the case of the analysis mode, the characteristic acquisition unit 12 is used to analyze previously measured data and obtain a characteristic of the subject's eye. In the case of the prediction mode, unlike the analysis mode, each time the analysis unit 13 acquires the information obtained by the acquisition unit 11, the analysis unit 13 analyzes the information and predicts a timing at which the blink of the subject's eye occurs.

### <Step S102>

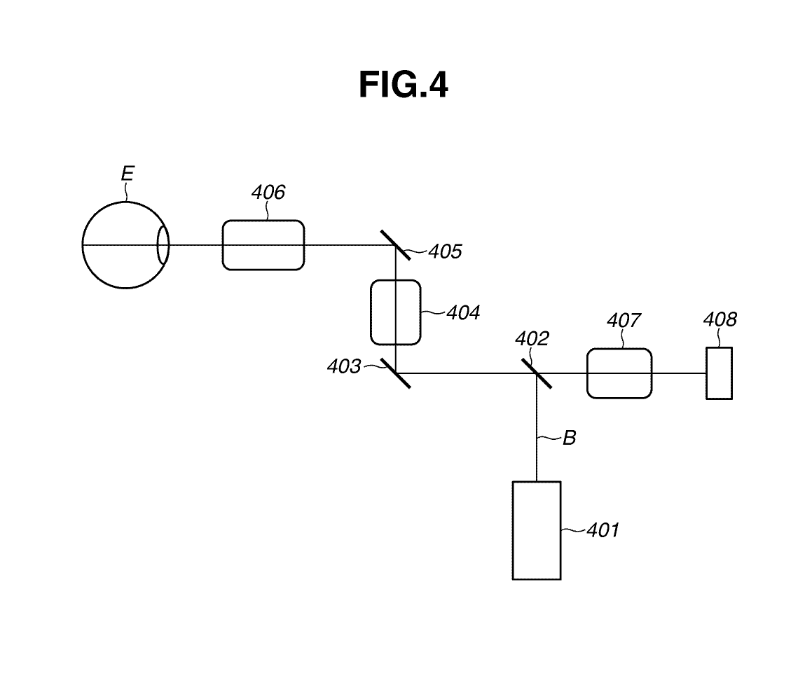

First, the acquisition unit 11 acquires an image of an ocular fundus used for the analysis. FIG. 4 illustrates a configuration of an image generation unit of the acquisition unit 11. In the present exemplary embodiment, the acquisition unit 11 includes a scanning laser ophthalmoscope (hereinafter referred to as an SLO). Further, the present invention is not limited thereto and any device may be used as long as the device can detect a position of an eyeball. However, it is necessary for the device to continuously detect the position change of the eyeball at a rate of about 10 frames or more per second, more preferably, tens of frames or more per second. For example, a distinctive area (a distinctive part) such as an iris of an anterior eye part may be traced as the motion of the eyeball.

In FIG. 4, 401 indicates a laser light source, such as a semiconductor laser or a superluminescent diode (SLD) light source, and a wave length of the laser light source is preferably 700 nm to 1000 nm, for example. A measurement light B output from the laser light source 401 is incident on a subject's eye E via a perforated mirror 402, a relay lens 404, scanners 403 and 405 arranged in front of and behind the relay lens 404 for scanning the measurement light B in orthogonal biaxial directions, and an eyepiece optical system 406. The measurement light B reflected by an ocular fundus of the subject's eye E travels back along an original path to form an image on a detector 408 via the perforated mirror and a relay lens 407. The detector 408 may be, for example, an avalanche photodiode (APD) and outputs a light intensity signal as an electric signal.

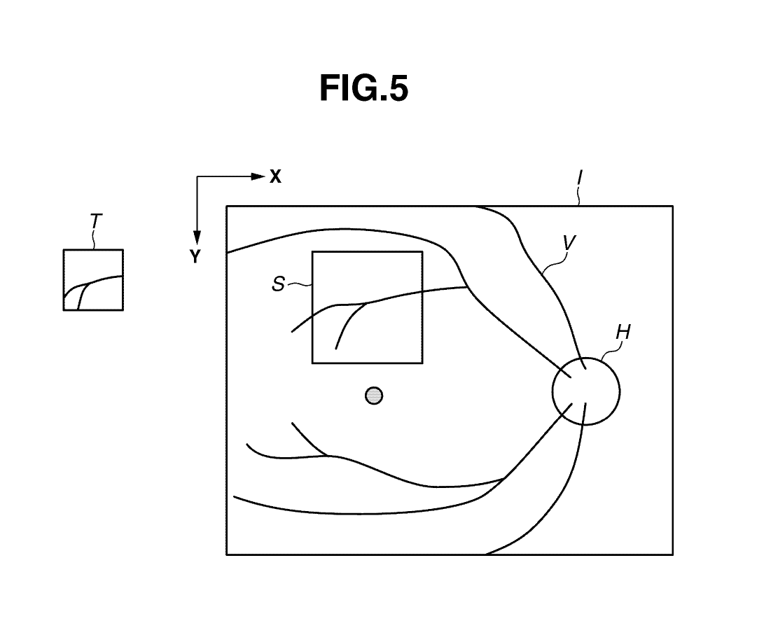

Meanwhile, the PC controls operations of the scanners 403 and 405 and the detector 408 and captures reflection intensity from the ocular fundus of the subject's eye as a two-dimensional SLO image. FIG. 5 illustrates an example of the SLO image. An optic papilla H and an ocular fundus blood vessel V are visualized in the SLO image I.

### <Step S103>

Next, the acquisition unit 11 detects a position of the eyeball from the SLO image I through template matching. In FIG. 5, a template T is a small area for detection of the position of the eyeball, which is extracted from the SLO image acquired from the subject's eye. The template T is a pattern for extracting a distinctive part having high similarity among images that are targets in a search area S. The template T may be manually extracted by an operator of the device or may be automatically extracted through image processing, but it is desirable that the template T includes a distinctive part that is a distinctive structure such as a branch of a blood vessel in order to confirm the position of the eyeball. The extraction may be performed from a first SLO image after photography of the subject's eye starts. Alternatively, an image may be selected in which distortion due to an involuntary eye movement during fixation is at a lower level and extracted from a plurality of SLO images acquired within a certain period of time.

When photography of the subject's eye starts after template extraction, template matching is executed for the SLO image sequentially acquired by the acquisition unit 11 and a position Pe of the eyeball is calculated by the PC. The template matching may be executed using a known technique. In an exemplary embodiment, a cross-correlation coefficient discussed in “Handbook of Image Analysis, Revised Edition,” supervised by Mikio Takagi, et al., University of Tokyo Press is used.

The position Pe of the eyeball is calculated as a coordinate value (x,y) in a coordinate system illustrated in FIG. 5 in the continuously acquired SLO images, and sequentially output to the characteristic acquisition unit 12.

### <Step S104>

The characteristic acquisition unit 12 analyzes a temporal change of components in an X direction (a horizontal direction) and a Y direction (a vertical direction) of the input position Pe of the eyeball. First, the characteristic acquisition unit 12 receives the SLO image together with the position Pe of the eyeball and determines whether a blink has occurred at the time of acquisition of each SLO image. When the blink occurs, a reflection light does not return to the detector 408 in FIG. 4 and an average of pixel values of the SLO image value is very small. Accordingly, this value may be used. More specifically, if an average of pixel values of the SLO image is less than a threshold, the blink is determined to have occurred, and the characteristic acquisition unit 12 acquires a predetermined motion of the subject's eye produced immediately before the blink occurs.

A suitable value of the threshold may be determined in advance through experiment and stored in a storage device such as a memory, which is available to the characteristic acquisition unit 12.

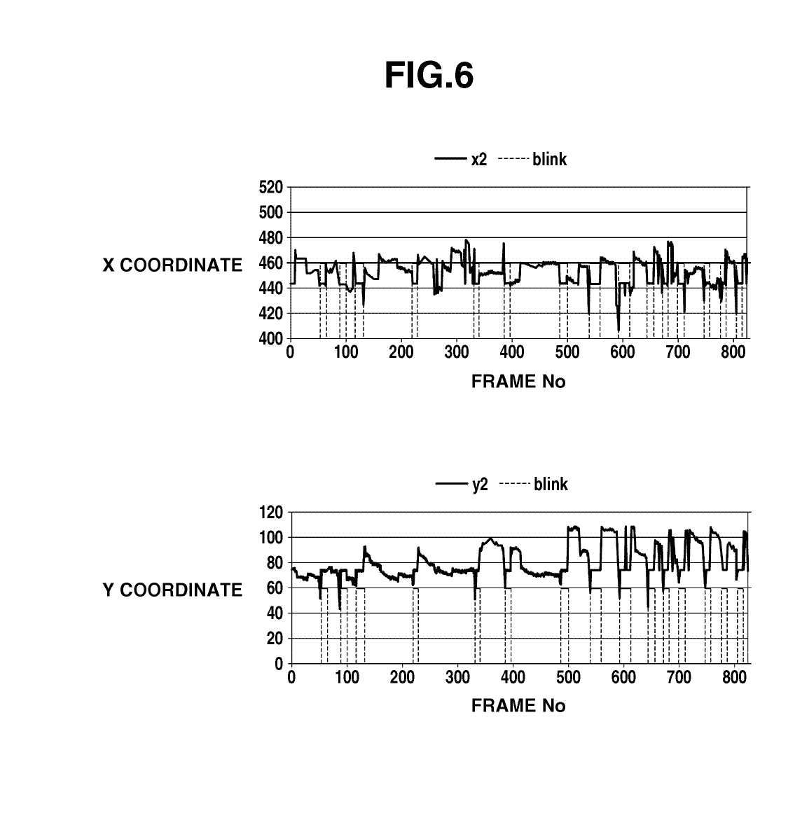

FIG. 6 illustrates a change in the position of the eyeball actually measured by the SLO illustrated in FIG. 4 for each component. In FIG. 6, a horizontal axis indicates frame No. (a number of the SLO image) and a vertical axis indicates a coordinate value in an X or Y direction. Further, a dotted line indicates a frame in which a blink occurs. For example, in a graph for the Y direction, the blink occurs near frame No. 540 to 560. Since pattern matching is impossible while the blink is occurring, a center coordinate of a search area in which the pattern matching is to be performed is set as a provisional value while the blink is occurring.

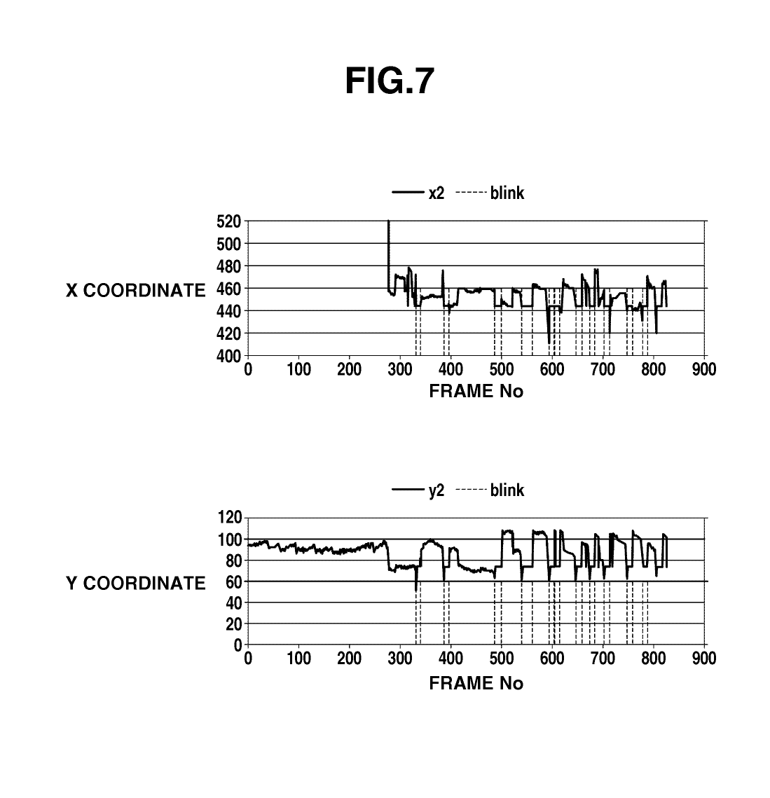

It can be seen from FIG. 6 that in the subject's eye, a frequency at which the eyeball rapidly moves in a negative direction of the Y axis becomes high immediately before the blink occurs. FIG. 7 is an illustration of another subject's eye. An eyeball rapidly moves in a negative Y direction immediately before blink occurrence, similar to the example of FIG. 6. Such a phenomenon was found for the first time by the applicant, and this characteristic is used in the present invention.

Specifically, the characteristic acquisition unit 12 calculates the movement speed of the eyeball immediately before the blink after detecting the blink, and calculates a prediction threshold Tp for blink prediction as characteristic information from a value of the movement speed. Specifically, the movement speed before the blink is calculated from the position Pe input from the acquisition unit 11 and a time interval between adjacent frames, and an average value of the movement speeds immediately before the blink is adopted as the prediction threshold Tp. More specifically, when the number of blinks generated in an analysis period is N, a movement speed V (i) for the i^{th} blink and Tp is obtained using the following equations.

[Math. 1]

V(i)={Pe(i)−Pe(i−1)}/T (1)

Tp=Σ(V(i))/N (2)
where i=0, 1, . . . , N−1, and T denotes a temporal interval between SLO images adjacent in terms of time, which is calculated from an acquisition rate of the SLO image.

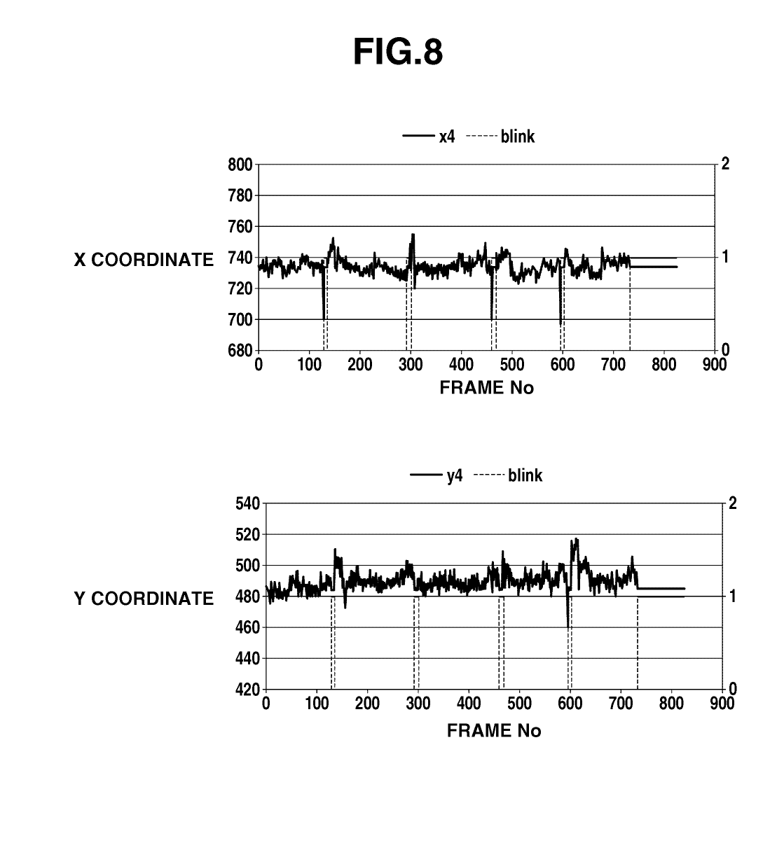

Further, FIG. 8 illustrates a position change of another subject's eye, in which a rapid movement immediately before the blink in the X direction rather than the Y direction is observed, unlike the two cases described above. Accordingly, the characteristic acquisition unit 12 analyzes the two directions of the X direction and the Y direction, selects the direction in which the change is greater immediately before the blink, and obtains a prediction threshold Tp. Here, it can be seen that the Y direction and the X direction correspond to a vertical direction and a horizontal direction for a tested person, respectively, and a characteristic of each subject person is obtained in the motion of the eye immediately before the blink. Accordingly, the characteristic acquisition unit 12 can accurately obtain blink occurrence timing by obtaining characteristic information of the subject's eye in advance. More specifically, the characteristic acquisition unit 12 may select the motion in the vertical direction or the horizontal direction depending on the subject's eye and obtain the blink occurrence timing.

Further, an absolute value of the eye motion of the subject's eye may be obtained from a size of a motion in both of the X direction and the Y direction to obtain the movement speed V(i) and Tp. In this case, the motion of the eye immediately before the blink, may be uniformly treated with the motion speed of the eye regardless of the subject person.

Here, the movement speed V(i) and Tp are used as representative values of a predetermined motion of the subject's eye.

Further, in this case, it is desirable for the characteristic acquisition unit 12 to perform removal of outliers. For example, in FIG. 7, two blinks seem to have occurred near frame No. 600, but the eyeball moves in a positive Y direction immediately before the second blink. This may occur when a signal is not blocked over an entire SLO image by an eyelid at the time of the blinking and a bright part and a dark part are mixed, so that false detection is caused by template matching.

Accordingly, the characteristic acquisition unit 12 may treat it as an outlier when a movement direction immediately before the blink is greatly different from others, and should not use it for the above-described calculation of the prediction threshold Tp. The thus calculated prediction threshold Tp and the direction D used for the prediction are output as characteristic information to the analysis unit 13. D may be, for example, 0 when the X direction is used for prediction and 1 when the Y direction is used.

Further, in the present exemplary embodiment, the number of frames used for the analysis is 800 as illustrated in FIGS. 6 and 7, but the present invention is not limited to that number. However, since it is necessary for a plurality of blinks to be contained in data that is an analysis target in the blink analysis, it is desirable to acquire and analyze the data approximately for over 10 seconds.

### <Step S105>

The prediction threshold Tp output from the characteristic acquisition unit 12 is stored in a memory of the analysis unit 13, which is not illustrated. The flow of the process returns back to S101 and enters a prediction mode in which an actual prediction operation starts. The flow of the process proceeds to step S106.

### <Step S106>

The acquisition unit 11 acquires an SLO image. Since details are the same as step S102, a description thereof will be omitted.

### <Step S107>

The acquisition unit 11 calculates the position of the eyeball for the SLO image through pattern matching and outputs the position of the eyeball to the analysis unit 13. Details of the pattern matching are the same as in step S103, and a description thereof will be omitted.

### <Step S108>

The analysis unit 13 calculates the movement speed of the eyeball from the input eyeball position Pe, as in step S104, and compares the movement speed of the eyeball with the prediction threshold Tp that is a predetermined value, which has been previously stored in step S105. However, the analysis unit 13 may select any one of the two directions of X and Y to perform analysis. In this case, the analysis unit 13 performs analysis of only a direction defined in the value of the direction D to be used for prediction, which is input from the characteristic acquisition unit 12.

As a result, when the movement speed is equal to or more than the prediction threshold Tp and the movement direction is the same as the direction in which the eyeball moves immediately before the blink in step S104, the blink is likely to continuously occur and a prediction signal S is output to the outside.

Further, the analysis unit 13 may perform the analysis from the motion in the two directions of X and Y, as described above.

### <Step S109>

When it is necessary for the PC to continuously receive the SLO image and perform the prediction, the process proceeds to S106 again. For example, when the blink measurement device of the present exemplary embodiment is linked to a photographing device for an ophthalmological clinic, a process in the present step is determined based on whether photography ends.

As described above, the blink measurement device according to the present invention can analyze the movement speed of the eyeball and the occurrence of the blink and predict the blink from the occurrence of the blink and the movement speed and direction of the eyeball. Further, the movement speed of the eyeball may be subjected to a subsequent analysis to analyze the occurrence of the blink. In this case, the blink start information may be analytically obtained.

In the first exemplary embodiment described above, the device for predicting the occurrence of the blink has been described. In the second exemplary embodiment, an effective application example of the blink measurement device according to the present invention will be described. Further, since a basic configuration of the blink measurement device in the present exemplary embodiment is substantially the same as that of the first exemplary embodiment, a description of the same parts will be omitted and different parts will be described in detail.

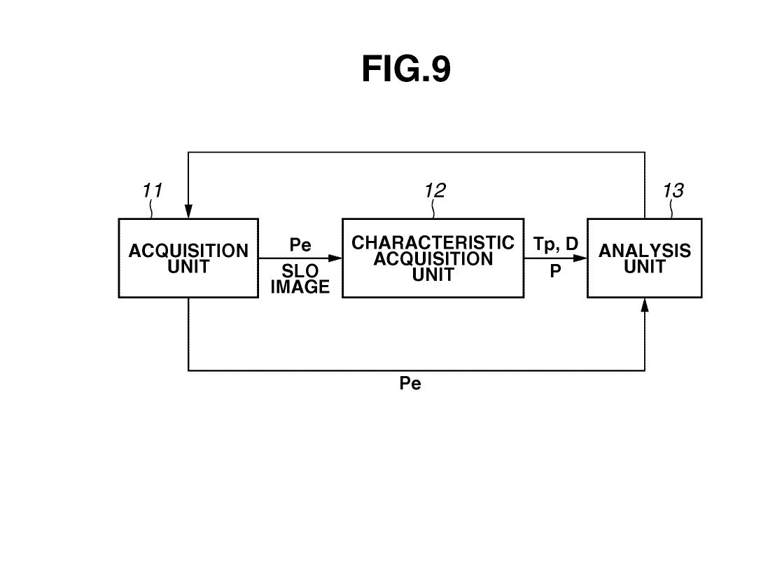

FIG. 9 illustrates a configuration of the blink measurement device in the present exemplary embodiment. In the present exemplary embodiment, a basic operation of each unit is the same as that of the first exemplary embodiment, but a characteristic acquisition unit 12 outputs a parameter to estimate a position of the eyeball after the blink, in addition to the movement speed of the eyeball immediately before the blink. Hereinafter, an operation of the characteristic acquisition unit 12 in the present exemplary embodiment will be described with reference to FIG. 6.

The characteristic acquisition unit 12 receives an SLO image together with a position Pe of the eyeball, and determines whether the blink has occurred at the time of acquisition of each SLO image using the method described in the first exemplary embodiment. Next, the characteristic acquisition unit 12 extracts the movement speed of the eyeball immediately before the blink occurrence and the position of the eyeball after the blink. For example, it is found that the eyeball position in the Y direction in FIGS. 6 and 7 is greatly changed after the blink occurrence in a positive direction from the position immediately before the blink occurrence and the eyeball tends to stay there for a certain time. The characteristic acquisition unit 12 adopts an average value P of the eyeball positions after the blink occurrence as the estimation position of the eyeball after the blink occurrence.

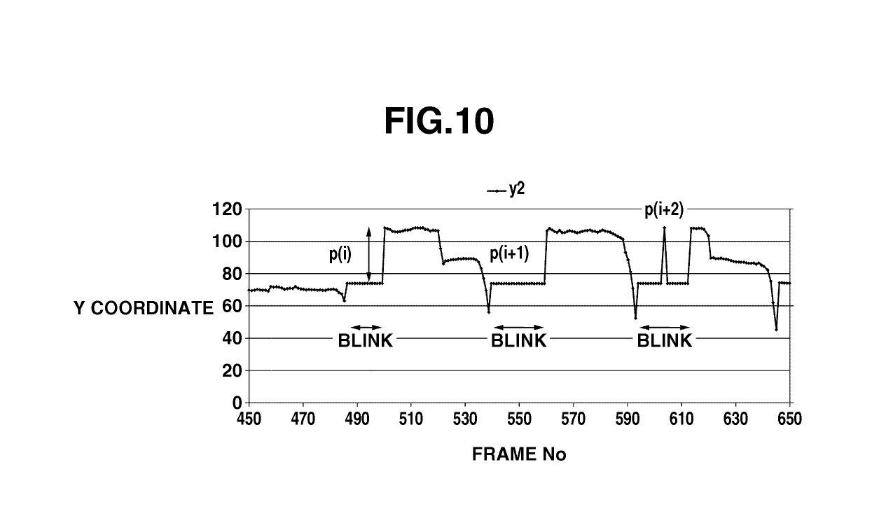

More specifically, if an eyeball position after an i^{th} blink is p(i) as illustrated in FIG. 10, the estimation position P is calculated as:

[Math. 2]

P=Σp(i)/N (3)

where the number of blinks occurring at the time of the analysis is N. The prediction threshold Tp and the prediction value P are output to the analysis unit 13, as in the first exemplary embodiment.

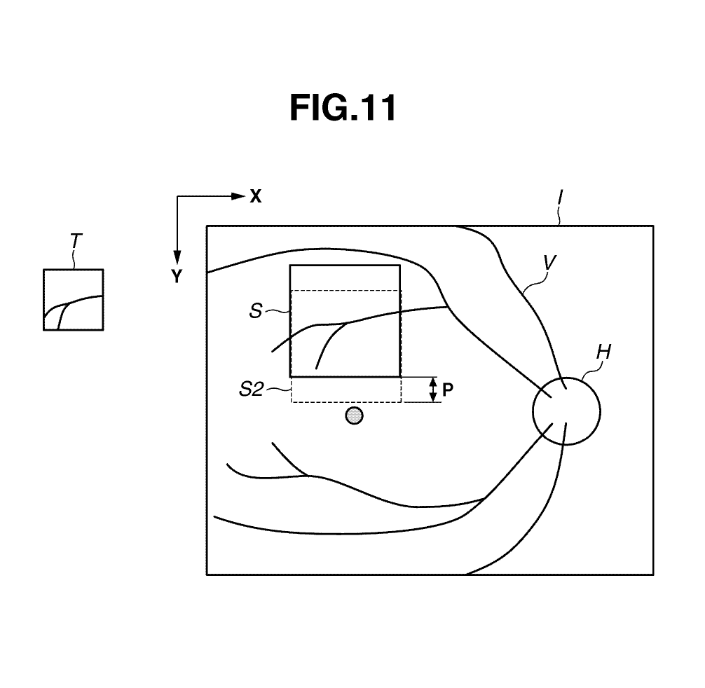

Next, if a mode is switched to a prediction mode, the analysis unit 13 predicts the blink from the eyeball position Pe, and outputs the prediction position P together with a prediction signal S to the acquisition unit 11 when the blink occurrence is predicted. As illustrated in FIG. 11, when template matching is performed for eyeball position detection, the acquisition unit 11 moves an area to be searched for a position matching with a template by an amount P in the Y direction, so that matching after the blink is performed in a modified search area S2.

Further, while the search area for template matching is moved only in the Y direction in FIG. 11, the search area may be moved in two directions when the motion in the X and Y directions is used as described in the first exemplary embodiment.

Thus, the position after the blink is predicted and reflected on a search position for next template matching. Accordingly, a pattern matching target is prevented from moving outside a search area even when the position of the eyeball is greatly deviated due to the blink, so that more stable tracking of an eyeball movement can be performed.

### OTHER EXEMPLARY EMBODIMENTS

In the respective exemplary embodiments described above, the prediction threshold Tp or the prediction position P that is the parameter for blink prediction is obtained each time. However, the parameter may be stored and reused for the subject's eye on which the analysis for the prediction has already been performed.

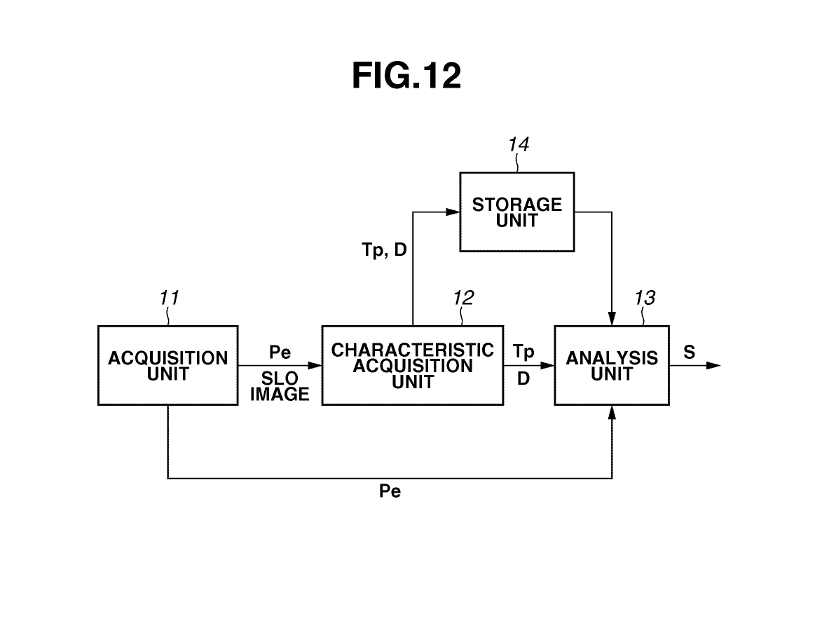

For example, as illustrated in FIG. 12, a storage unit 4 is added to the configuration of FIG. 1, and an output of the characteristic acquisition unit 12 is input to the analysis unit 13 and the storage unit 14 to be stored in the storage unit 14. In this case, a unique number for specifying the subject's eye is input from an input unit, which is not illustrated, and stored together with the prediction threshold Tp.

Next, when prediction for the same subject's eye is performed, the PC determines whether there is already information of a subject's eye having the same number in the storage unit 4 through search. When there is the information of the subject's eye, the analysis unit 13 can receive the prediction threshold Tp from the storage unit 14, and when there is no information of the subject's eye, a parameter necessary for the prediction can be determined through the procedure illustrated in FIG. 3.

As described above, according to the present invention, the blink can be predicted in advance and more efficient photography can be performed in a photographing device for eyes.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-184618 filed Aug. 26, 2011, which is hereby incorporated by reference herein in its entirety.

1. A blink measurement device comprising:
an acquisition unit configured to acquire motion information of a subject's eye; and
an analysis unit configured to obtain timing when a blink of the subject's eye starts based on the motion information.

2. The blink measurement device according to claim 1, wherein the analysis unit analyzes the start information and determines that the blink of the subject's eye starts when the subject's eye performs a predetermined motion.

3. The blink measurement device according to claim 1, wherein the analysis unit analyzes the start information and determines that the blink of the subject's eye starts when the movement speed of the eyeball immediately before the blink exceeds a predetermined value.

4. The blink measurement device according to claim 1, wherein the analysis unit selects a motion in any of a vertical direction and a horizontal direction according to the subject's eye and obtains blink occurrence timing.

5. The blink measurement device according to claim 1, wherein the acquisition unit includes a scanning laser ophthalmoscope, and acquires a motion of a distinctive part of an ocular fundus of the subject's eye captured by the scanning laser ophthalmoscope as motion information of the subject's eye.

6. The blink measurement device according to claim 1, wherein the analysis unit estimates an eyeball position taken after the blink occurrence.

7. The blink measurement device according to claim 1, wherein the analysis unit predicts blink occurrence timing.

8. The blink measurement device according to claim 1, further comprising:
a characteristic acquisition unit configured to acquire characteristic in-formation of the subject's eye; and
a storage unit configured to store the characteristic information,
wherein the analysis unit obtains timing when a blink of the subject's eye starts based on the characteristic information stored in the storage unit.

9. The blink measurement device according to claim 1, wherein the acquisition unit acquires an involuntary eye movement during fixation of the subject's eye as the motion information of the subject's eye.

10. A blink measurement method comprising:
acquiring motion information of a subject's eye; and
performing analysis to obtain timing when a blink of the subject's eye starts based on the motion information.

11. A program for causing a computer to execute the blink measurement method according to claim 10.
